(19) United States
(12) Patent Application Publication
(10) Pub. No.: US 2008/0302489 A1
(43) Pub. Date: Dec. 11, 2008

(54) CURTAIN BODY POSITIONING CONTROL STRUCTURE FOR THE WINDOW CURTAIN

(76) Inventor: Ming-Lu WONG, Niaosong Hsiang (TW)

Correspondence Address: SINORICA, LLC, 528 FALLSGROVE DRIVE, ROCKVILLE, MD, 20850, US

(21) Appl. No.: 11/760,050

(22) Filed: Jun. 8, 2007

(51) Int. Cl. E06B 9/36; E06B 9/324

(52) U.S. Cl. 160/168.1 V; 160/178.2

(57) ABSTRACT

The present invention relates to a kind of curtain body positioning control structure for the window curtain, there is a shaft extruding from the side fixing base of such window curtain coupling with the bead-chain driving mechanism, locking device and fixing base respectively, wherein the said locking device consisting of top push block and locking block, thereat the combination of locking device with locking block is maintaining an elastic condition, due to such locking block is pushed against a spring, in addition, said fixing base is connected to the said locking device with rolling beads particularly, and in this way while such window curtain is being opened or closed by means of bead-chain driving mechanism, a gap between the said locking device and said shaft will be formed with the spring action thereto and hence reducing lots of detent force accordingly, therefore it has an advantage of easy operation; when the curtain is stopping operation, the locking device would be swiveled reversely as well as drawn downwardly by the gravity force of such window curtain, and hence resulting in a various separation distance of the rolling beads which is caused by the displacement of said rolling beads, and under this circumstance a cone hole inside the said locking device will be pushed forwardly to tightly slip onto the said shaft and hence preventing such window curtain from falling downwardly with a locking effect thereof.

### 1. FIELD OF THE INVENTION

The present invention relates to a kind of curtain body positioning control structure for the window curtain particularly.

### 2. THE PRIOR ARTS

The current design of control apparatus is for the window curtain with rolling shaft. The concept of its structure technique primarily lies in the lug of side fixing base of such curtain, which has two springs, therein the end of such spring is pushing against the driving block of bead-chain swivel base. When such bead-chain swivel base is revolving, it will push the spring away and hence changing the harnessing condition into the releasing condition. Furthermore it enable the ability to open/close such window curtain. While the curtain is being rolled-up to a certain position, due to the gravity force of such curtain, it will release the driving block of bead-chain swivel base from the spring, so that such spring will be contracted onto such lug, and in this way, such curtain will be locked at certain position with the contraction force of the spring; however, due to the extruding front end of the spring is very tiny and unfixed, the operation of such window curtain could be stuck easily, where it isn't so functional. More over, when the curtain is being rolled-up, the curtain would always be drawn downward due to the weight of such curtain is higher than the contraction force of spring, and hence resulting in an improper rolled-up position for the curtain, which is being operated uneasily.

### SUMMARY OF THE INVENTION

It is therefore a primary object of present invention to provide a curtain body positioning control structure for the window curtain, which can be easily operated.

It is a further object of present invention to provide a curtain body positioning control structure for the window curtain to keep the curtain position from sliding.

The curtain body positioning control structure for the window curtain of the present invention comprises particularly a shaft extruding from a fixing base which is coupling with the bead-chain driving mechanism, locking device and fixing base sequentially; wherein said locking device consisting of top push block and locking block; thereat the combination of locking device with locking block is maintaining an active condition, due to the said locking block is pushed against a spring. In addition, there are retaining grooves for the rolling beads corresponding to the said fixing base, said locking device and said locking block respectively; therein by the time while the rolling beads are connecting to such retaining grooves, if someone would like to open/close such window curtain with the operation of such bead-chain driving mechanism, then a gap between the said locking device and said shaft will be formed with the spring action thereto and hence having an easy operation by reducing lots of detent force thereof. When the curtain stops the operation, said locking device would be swiveled reversely as well as drawn downward by the gravity force of such window curtain, and hence resulting in a certain separation distance of the rolling beads due to the said rolling beads are driven aside from the center of said retaining groove of such rolling beads. Further more, such locking block will be pushed forward caused by the displacement of such rolling beads. While under this circumstance, a cone hole inside the said locking device will be pushed forward to tightly slip onto said shaft, and hence having a positioning effect by preventing such window curtain from falling downward with a locking effect thereof; however, supposed that someone would like to close such curtain furthermore, then it is available for her/him to have the bead-chain to draw the bead-chain driving mechanism downward and also start swiveling thereat, so that the top push block will start swiveling together with the driving block sequentially. Under this way, while the guide incline is being guided with the gap of top push block, it will then being pushed against the drift angle located at the front end of such locking block, and hence creating a displacement of the locking block. Under this circumstance, the central cone hole of said locking block will be released out of cone of shaft of such fixing base from its locking condition, and thus achieving an objective of easy operation as well.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded view of the present invention;

FIG. 2 is a perspective view showing the present invention under the assembled condition;

FIG. 3 is a cross-sectional view showing the present invention under assembled condition;

FIG. 4 is an exploded view showing the components of the present invention;

FIG. 5 is a schematic view showing the assembled/disassembled condition of the present invention;

FIG. 6 is a schematic view showing the operation of the present invention;

FIG. 7 is a schematic view showing the movement of the present invention;

FIG. 8 is a schematic view showing the locking operation of the present invention;

FIG. 9 is a schematic view showing the present invention under the locking condition;

FIG. 10 is a schematic view showing the present invention under the unlocking condition; and

FIG. 11 is a schematic view showing the unlocking action of the present invention.

### DETAILED DESCRIPTION OF THE PREFERRED EMBODIMENT

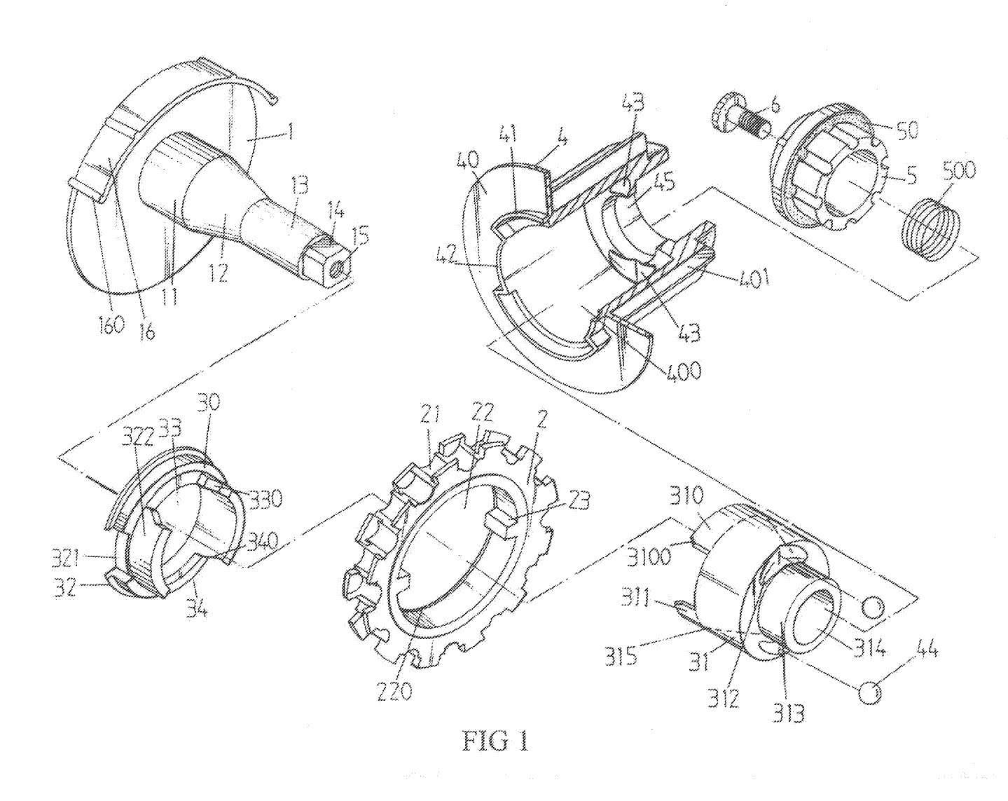

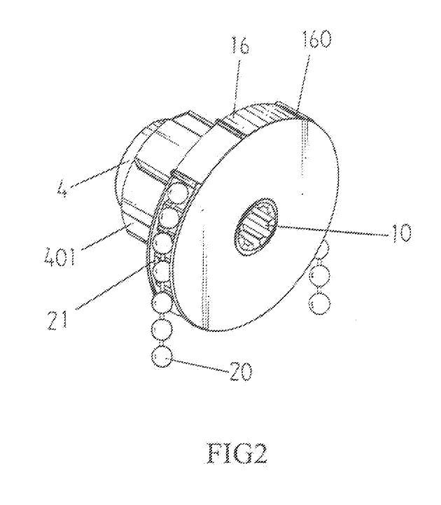

With reference to both FIG. 1 and FIG. 2, the control structure of the present invention comprises primarily the fixing base 1, the bead-chain driving mechanism 2, the locking device 3 and the fixing base 4, which are all assembled with screws 6 as an integrated structure through the fixing block 5; wherein, the fixing base 1 has a disc block structure, and there are fixing holes 10, locating at the central area of side disc block, equipped for fixing frame. In addition, there is a shaft 11 extruding from the central area of its inner side, wherein the central portion of such shaft 11 is formed as a cone structure 12, and also another the seamy side faces then central is convex to stretch the shaft stem 11. The shaft's stem 11 of medium segment 12 is structured as cone; thereat the front end of such cone 12 has extruded and formed a cylinder with a smaller diameter. Such cylinder 13 has an extruded front end with a square block 14 structure, in which there are screw holes 15 equipped at the surface of such square block 14 for receiving screws 6. In addition, the cover body 16 of the bead-chain driving mechanism 2 is positioned at the same side of shaft 11 of such fixing base 1, which has several reinforcing ribs 160 in order to improve the strength of the said cover body 16. Said bead-chain driving mechanism 2 has a disc block structure, thereat there are several retaining grooves 21 formed at the periphery used for retaining bead-chain 20. There are also through holes 22 formed at the central area of such disc, and furthermore, driving blocks 23 are extruding from both sides of such through hole 22 respectively, wherein said through hole 22 has a groove 220 at one side for providing the locking function accordingly. In addition, the locking device 3 consists of top push block 30 and locking block 31, therein the flange 32 is constructed at the outer edge of such top push block 30; in which the size of said flange 32 is in accordance with the size of groove 220 constructed at one side of the said bead-chain driving mechanism 2, which locates at both sides of the flange 32. There is a driving groove 321 suitable for being pushed against driving block 23 of the bead-chain driving mechanism 2 which is applicable for combining with its central through hole so as to retain the top push block 30 together with groove 220. Furthermore, a hollow cylinder 322 is extruding from the front end of the said top push block 30, and also two gaps are formed at the position which the hollow cylinder 322 is facing vertically to the said driving groove 321. Both sides of these two gaps 33, 34 are constructed as guide incline 330, 340, and under this circumstance, the front ends of said gap 33, 34 will be coupled with the corresponding coupler 310, 311 of the said locking block 31 with its drift angle 3100 and hence formed as an integrated structure. The retaining grooves 312 for the rolling beads is also formed at the opposite side of the said coupler 310 and 311 and have concave bevel groove structure, where there is an extruded post 313 positioned in-between which has a through hole 314 thereto as well as a cone hole 315 going through inside of the said locking block 31. Such cone hole 315 is designed particularly at the same size in accordance with the cone 12 of such fixing base 1. The fixing base 4 of window curtain has a hollow cylinder structure, wherein the disc block 40 structure can be used to block the side end of bead-chain driving mechanism 2 at side end of such disc block 40. There is a flange 41 having a concave structure 42 at each side, respectively, applicable for contacting with the disc block of such fixing block 1 via driving block 23, and the other side of such disc block 40 is formed as a hollow cylinder structure 400 with an external fixing piece 401; therein its central space is used for retaining the locking device 3 after assembly. The rolling beads retaining groove 312, formed at the bottom surface of this central space, is combined with rolling beads retaining groove 43, and after assembly, the rolling beads 44 is installed in-between for connecting with both the rolling beads retaining grooves 312 and 43, a smaller space 45 will be constructed at the other end of such rolling beads retaining groove 43, which allows the front end of said retaining the washer 50 of fixing block 5 to be locked the spring 500 onto the concave post 313 of the locking block 31. In this way, the locking block 31 will be in a flexible condition due to it is pushed forward, which causes the internal cone hole 315 to be coupled tightly onto the shaft 12. In addition, it is available to screw in the screw hole 15 at the shaft 11 of the fixing base 1 with screws 6, so that the fixing base 4 and fixing base 1 of such window curtain will be fastened tightly and thus the assembly procedure of the whole control structure is accomplished accordingly.

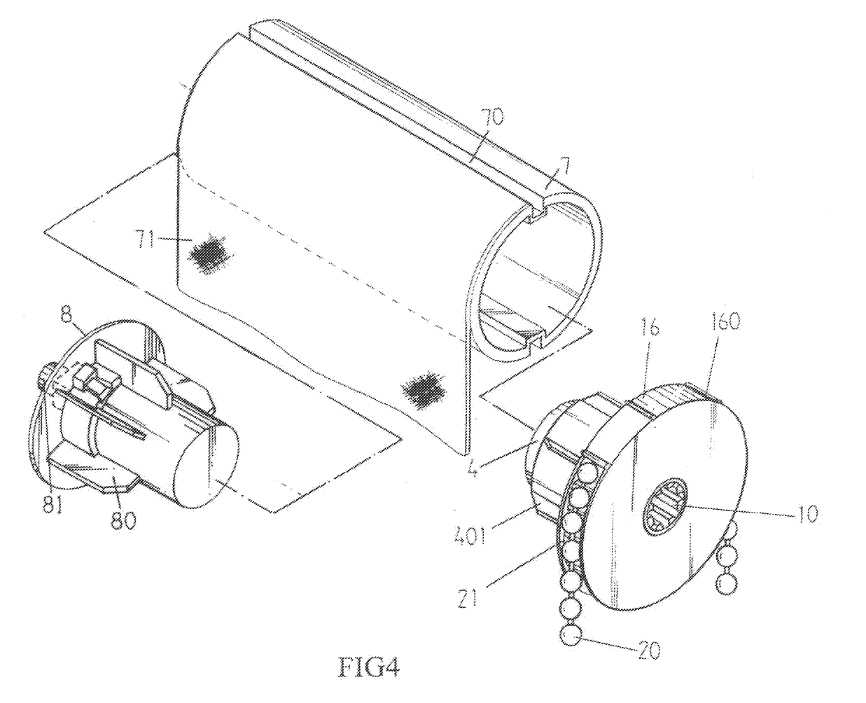

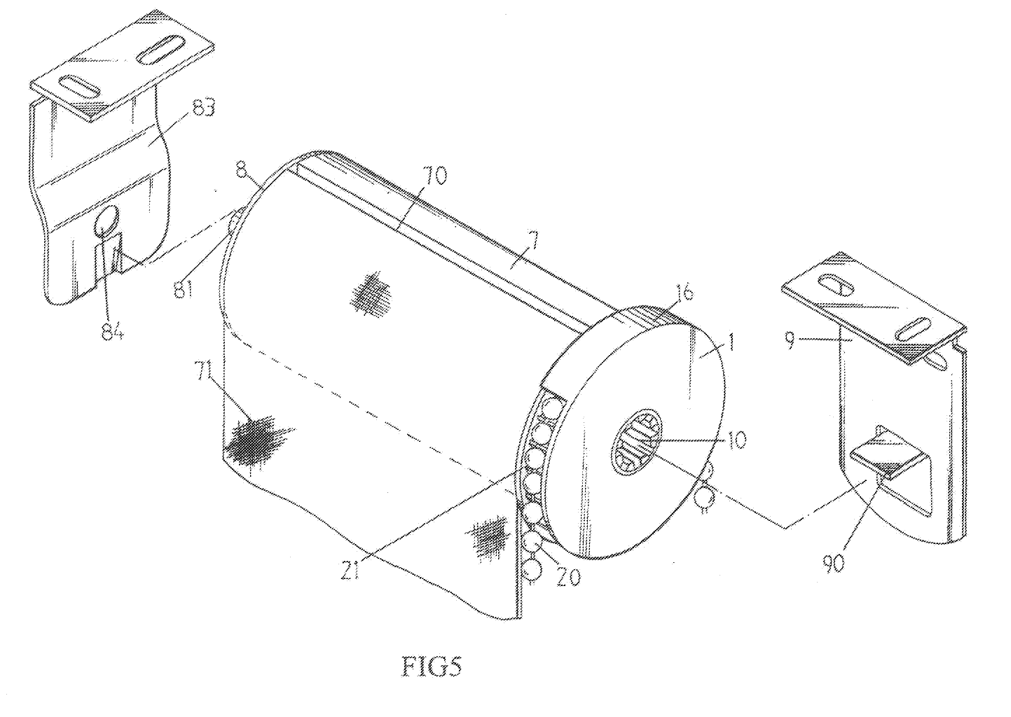

Again, as shown in FIG. 4, the assembly procedure for the window curtain utilizes the fixing piece 401 positioning outside of the fixing base 4, which is fastened at one end of fixing tube 7 of curtain fabric. Said fixing tube 7 has reinforcing trench 70 at both its top/bottom end, where the curtain 71 has been stuck at the edge of such trench, and in addition, the other end of such fixing tube 7 is coupled by means of fixing edge 80 of a fastening base 8, together with an elastic type extruded post 81. Also with reference to FIG. 5, while fixing the curtain onto a window, it is applicable to have the fixing hole 10 at side fixing base 1 of such window curtain coupled with the plate 90, which extrudes from the fixing plate 9. Furthermore, the other end of such curtain can be positioned onto the fixing hole 84 of the fixing plate 83, which is located at the ceiling with an elastic post 81 of the fastening base 8.

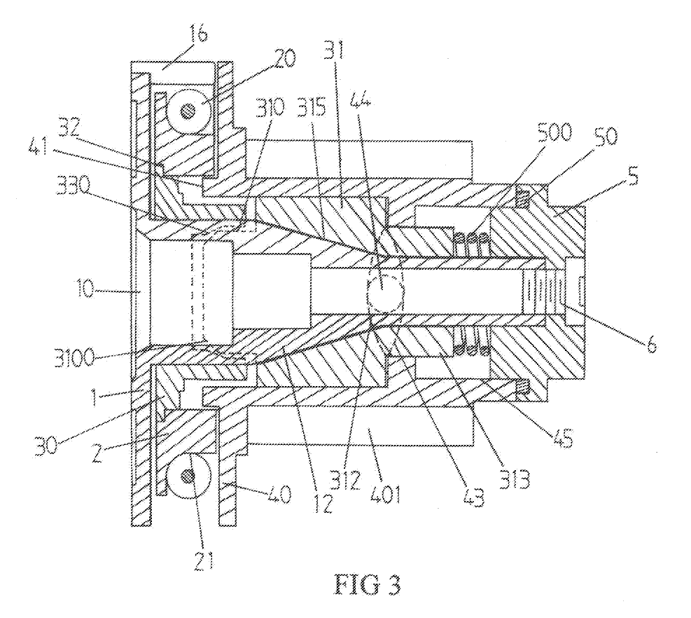

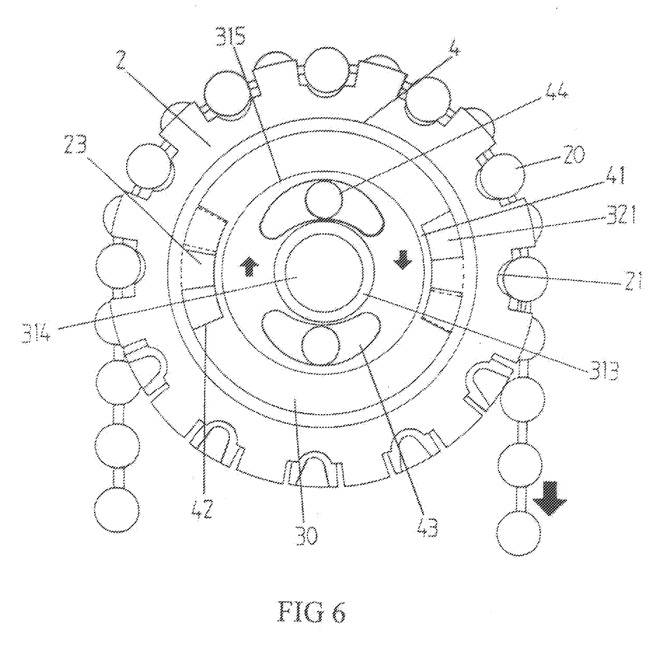

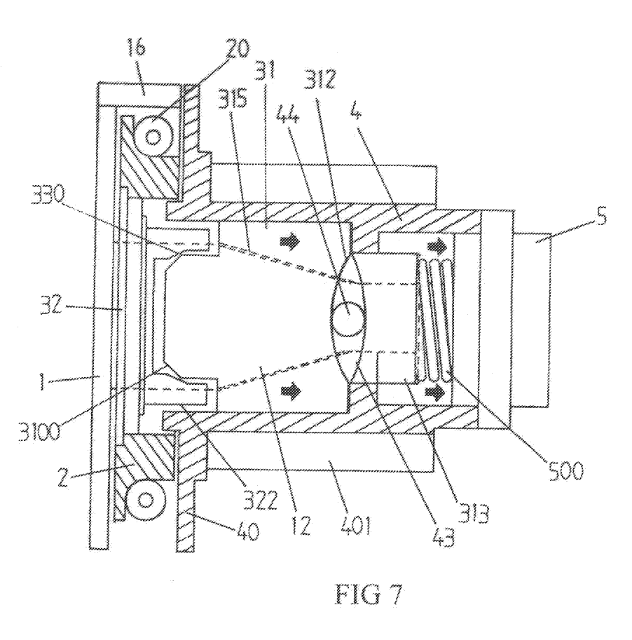

As shows in FIG. 6, while the curtain is being rolled-up, it is available to pull the bead-chain driving mechanism 2 downward with the bead-chain 20 in order to drive and swivel the said bead-chain driving mechanism 2; wherein the driving block 23 of such bead-chain driving mechanism 2 is pushing against the top push block 32 of locking device 3 and hence forming a concave structure 42 consisting of driving groove 321 together with flange 41 of fixing base 4 while the driving block 23 of such bead-chain driving mechanism 2 is pushing against the top push block 32 of the said locking device 3. Furthermore, it is able to swivel locking block 31 and fixing base 4 at the same time causing the fixing base 4 fastens the fixing tube 7 of the curtain fabric (also referring to FIG. 3). In this way, the window curtain 71 can be rolled upward while swiveling the driving block 23 of bead-chain driving mechanism 2, due to the locking block 31 is driven by the elastic action caused from the spring 500, so cone hole 315 and cone 12 of shaft 11 of the fixing base 1 can be connected flexibly (as shown in FIG. 7) without being locked completely; therefore, it is able to reduce the detent force of fixing base 4 of such window curtain, which in turn makes it easier to operate the window curtain.

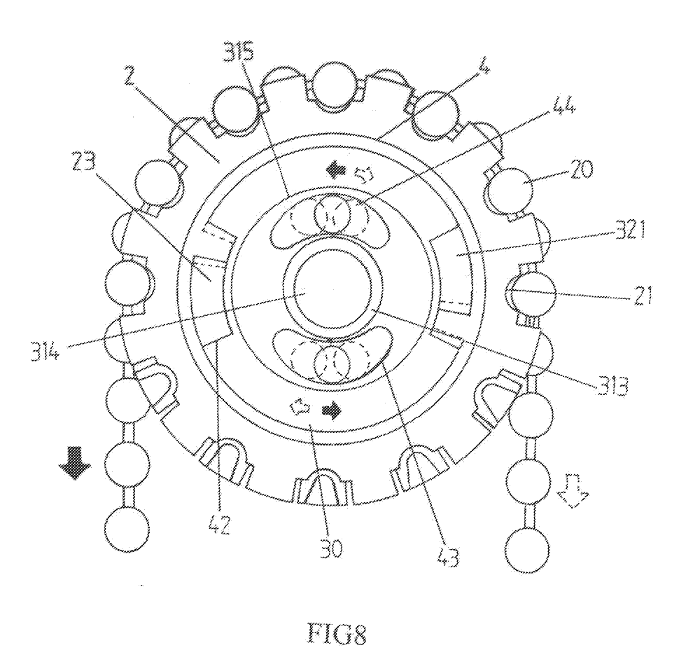

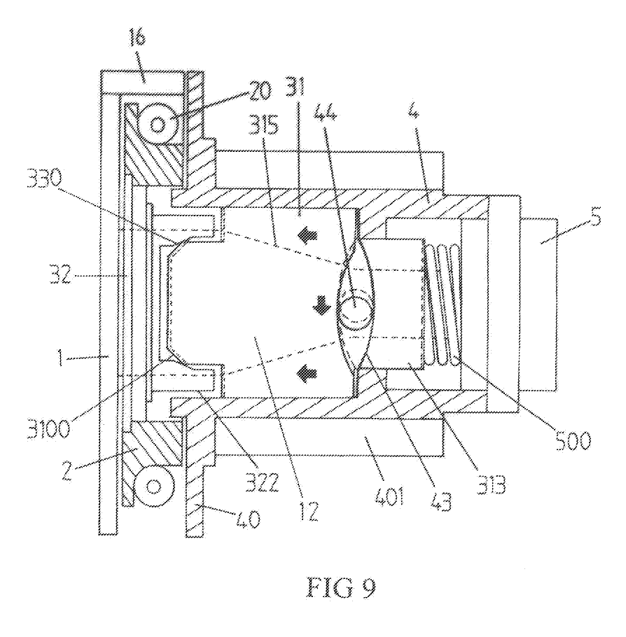

When stop pulling the bead-chain 20 of such curtain (as shown in FIG. 8, also referring to FIG. 5), the window curtain 71 faces to different direction and tends to the direction of left or right hand side resulting from the gravity face. Meanwhile the fixing base 4 of such curtain swivels reversely while being pulled downward causing the locking block 31 swiveling at the same time, and hence the rolling beads 44 will move to one side. As the result, the locking block 31 moves forward to push the front end of the drift angle 3100 against the guide incline 330 of top push block 32, and hence driving the central cone hole 315 locked tightly with cone 12 of shaft 11 of the said fixing base 1 so that the window curtain can be easily locked at the proper position with the rolling beads (as shown in FIG. 9).

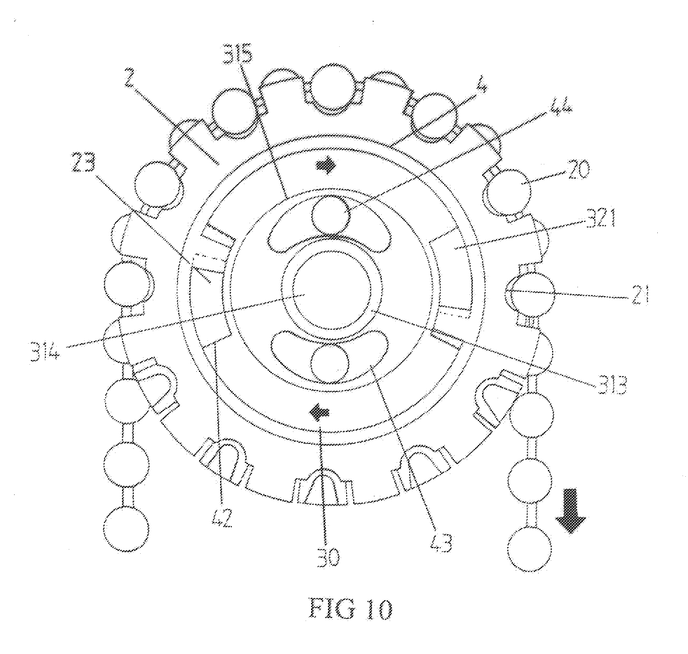

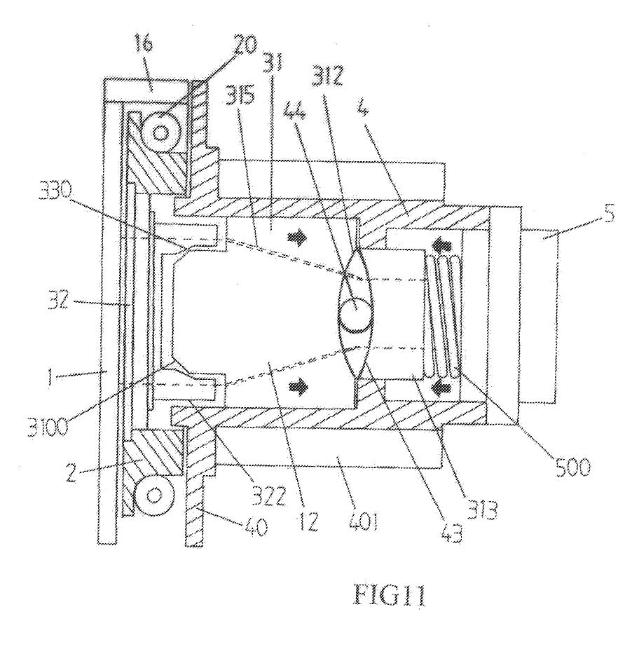

If someone would like to pull the curtain upward again (as shown in FIG. 10), then it is available to have the bead-chain driving mechanism 2 swiveled by pulling the bead-chain downward. As the result, the top push block 32 will be swiveling at the same time with the driving block 23. Under this circumstance, the guide incline 330 of gap 33 of such top push block 32 is pushing the locking block 31 and resulting in a displacement; therefore, the locking condition between the central cone hole 315 and the cone 12 of shaft 11 of the said fixing base 1 will be released again causing unlocked condition performed flexibly, so that the window curtain will be pulled upward easily (as shown in FIG. 11).

1. A curtain body positioning control structure for a window curtain comprises:
a washer of a fixing block;
a spring;
a plurality of rolling beads;
a fixing base comprising a shaft, wherein central portion of said shaft has a cylinder structure, and in addition, there is a screw hole formed at front surface of said cylinder structure;
a bead-chain driving mechanism comprising multiple bead-chain retaining grooves formed at its periphery, wherein a through hole is positioned at central area for receiving said shaft, and wherein there are driving blocks formed at corresponding position of said through hole;
a locking device comprising a top push block and a locking block, wherein there are driving grooves formed at both sides of the said top push block of said locking device, which is connected with said driving blocks of said bead-chains driving mechanism and also movable all together at the same time; wherein said locking block comprising locking block retaining grooves for said rolling beads and an internal cone hole;
a curtain fixing base, comprising concave structures applicable for contacting with said bead-chain driving mechanism via said driving blocks, a space in central portion suitable for retaining said locking device, and curtain fixing base retaining grooves for said rolling beads;
wherein said locking block retaining grooves and said curtain fixing base retaining grooves of said rolling beads has a concave arc gutter structure;
wherein said rolling beads are installed in-between said locking block retaining grooves and said curtain fixing base retaining grooves;
wherein front end of said washer of said fixing block locks said spring onto front end of said locking block, which allowing said locking block being flexibly pushed forward and causing said cylinder structure being coupled tightly onto said internal cone hole; which then causing said fixing base and said curtain fixing base being fastened tightly.

2. The curtain body positioning control structure for the window curtain as claimed in claim 1, wherein an integrated structure is formed while the said fixing base is being combined with the said shaft.

3. The curtain body positioning control structure for the window curtain as claimed in claim 1, wherein front end of said shaft is formed as a square block structure.

4. (canceled)

5. (canceled)

6. The curtain body positioning control structure for the window curtain as claimed in claim 1, wherein said top push block and said locking block are symmetrically integrated into a coupled structure consisting of drift angle and incline.

7. (canceled)

8. The curtain body positioning control structure for the window curtain as claimed in claim 1, wherein said top push block and said locking block of said locking device is integrated as a single component.
